(19) United States
(12) Patent Application Publication
(10) Pub. No.: US 2008/0047946 A1
(43) Pub. Date: Feb. 28, 2008

(54) Heated floor board

(76) Inventors: Kenneth Van Klompenberg, Muskegon, MI (US); Russell Van Klompenberg, Muskegon, MI (US)

Correspondence Address: SUNG I. OH, PROFESSIONAL LAW CORPORATION, 710 QUAIL VALLEY LANE, WEST COVINA, CA, 91791, US

(21) Appl. No.: 11/500,752

(22) Filed: Aug. 8, 2006

(51) Int. Cl. H05B 3/00

(52) U.S. Cl. 219/213

(57) ABSTRACT

A flooring system includes a plurality of connectable sheet elements that have heating wires embedded therein. The sheet elements include starting sections, ending sections, middle sections and corners sections with the thermostat having long wires for connection to the starting and ending sheets. The sheet elements can be used in a bathroom or the like. The floor system of the present invention is installed underneath tile floors to heat the tile floor.

### TECHNICAL FIELD OF THE INVENTION

The present invention relates to the general art of building materials, and to the particular field of flooring.

### BACKGROUND OF THE INVENTION

In heating the interiors of buildings, several conventional heating methods have been employed, including hot water/steam and forced air heating. Generally, these heating methods require the installation of large air ducts or extensive water piping, both of which take up a considerable amount of space within a building and require careful planning for locations of vents, radiators, and so forth. Vents and ducts tend to obstruct living and working areas within a building and require other components of the building (ceilings, walls, etc.) to be designed around them. Some hot water systems include piping which is embedded in a flooring or ceiling material through which warm water is circulated to heat a building. In some geographic localities, however, electrical power is cheaper than gas, and direct electric heating is desired.

In heating the interiors of buildings and of building floors, several conventional heating methods have been employed, including hot water/steam and forced air heating. Generally, these heating methods require the installation of large air ducts or extensive water piping, both of which take up a considerable amount of space within a building and require careful planning for locations of vent, radiators and so forth. Vents and ducts tend to obstruct living and working areas within a building and require other components of the building (ceilings, walls, etc.) to be designed around them. Some hot water systems include piping which is embedded in a flooring or ceiling material through which warm water is circulated to heat a building. In some geographic localities, however, electrical power is cheaper than gas, and direct electric heating is desired.

Electric heating cables have been employed to heat cement slabs and the like by being positioned in a layer beneath the slabs. High limit switches have been employed adjacent the cables to sense the cable temperatures and to prevent the cables from over heating. Temperature sensors imbedded in the concrete slabs regulate the electric current supplied to the heating cable, thereby regulating room heat by controlling the temperature of the concrete where the electric heating cables are embedded. Positioning the temperature sensors in the room air space above the flooring results in prohibitively long response times.

Heated floors are previously known in a number of different forms, for example a plaster netting can be laid on top of the supporting structure and be fixed to the surface of the floor structure by gluing, for example. The electrical heating cable is then fixed to the plaster netting, first being laid out in a loop pattern and then being fixed by hot melt adhesive to the plaster netting. When the electrical heating cable has been completely laid out, it is covered with a plastering material in such a manner as to cover completely. The covering plaster is then allowed to dry and is then provided with an adhesive for laying, so-called clinker. The disadvantages of these methods are the risk of having the wrong cc-distance between the heating cables, a too small bending radius which involves the risk of cable breakage in addition to the fact that laying, drying and curing take a long time before the electrical heating cable can be used, usually one month. Similar constructions are also available where the electrical heating cable has been replaced by water pipes, for example PEX-piping.

In other floor systems that the inventor is aware of, it is required that wires must be mudded in with thinset over the cement board which is time consuming and makes the floor difficult to level.

### SUMMARY OF THE INVENTION

The above-discussed disadvantages of the prior art are overcome by a flooring system that includes a plurality of connectable sheet elements that have heating wires embedded therein. The sheet elements include starting sections, ending sections, middle sections and corners sections with the thermostat having two long wires that connect to the start and end sheets. The sheet elements can be used in a bathroom or the like. The floor system of the present invention is installed underneath tile floors to heat the tile floor.

Using the flooring system embodying the present invention eliminates the step of installing the heated floor over the cement board. This will reduce the cost, at least in installation time.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a flooring system embodying the present invention.

FIG. 2 is a sectional view taken along line 2-2 of FIG. 1.

FIG. 3 is a perspective view of a middle sheet of the flooring system embodying the present invention.

FIG. 4 is a perspective view of a corner sheet of the flooring system embodying the present invention.

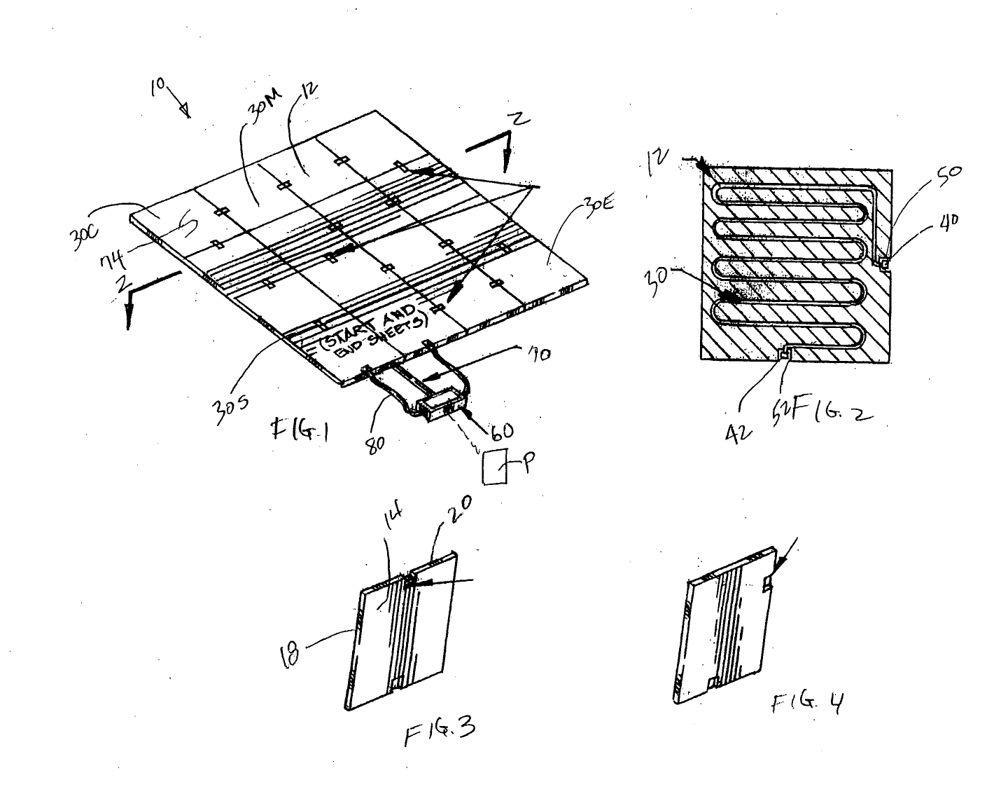

### DETAILED DESCRIPTION OF THE INVENTION

Referring to the figures, it can be understood that the present invention is embodied in a flooring system 10. Flooring system 10 comprises a plurality of sheets, such as sheet 12. Each sheet includes a first surface 14 that is a top surface when the sheet is in use, a first edge 18 and a second edge 20. An electrical resistance heating wire 30 is embedded in each sheet and is sinuous in shape as shown in FIG. 2. The plurality of sheets includes a starting sheet 30S, an ending sheet 30E, a middle sheet 30M and a corner sheet 30C. The sheets are laid in the usual manner.

A first connector 40 is on the first edge of each sheet and a second connector 42 is located on the second edge of each sheet. As can be understood from the figures, the first and second connectors are electrically connected to the heating wire embedded in each sheet and are adapted so that a first connector on one sheet can be electrically connected to a second connector on an adjacent sheet whereby a single electrical circuit is defined through a floor formed of the plurality of sheets.

Sheet connectors 50 and 52 are located on each sheet and are adapted to physically connect each sheet to at least one adjacent sheet. The sheet connectors are designed to connect to each other or to sink into the thinset flush with the board. A power source P, such as utility power or the like is used to supply electricity to the heating wire to cause that wire to generate heat.

A thermostat 60 is connected to the starting and ending sheet and power source and a thermometer 70 is connected to one of the sheets and to the thermostat. The thermostat is set to a desired temperature and the sheet temperature is read by the thermometer. When the sheet temperature reaches the temperature set on the thermostat, the thermostat either reduced power to the heating wire or shuts off power to the thermostat in a manner well known to those skilled in the thermostat art.

Each sheet is marked with a mark 74 so an installer will know where the heating wire is located. This will permit the installer to avoid placing a nail or a screw through the heating wire. The thermostat will have extra long wires, such as wire 80, to leave slack for the wire to run along the wall to go down to the starting and ending sheets. The board will be installed with thinset and nails or screws.

Areas where traffic will not occur can be formed using sheets which do not include heating wire if desired. The floor system of the present invention is installed underneath tile floors to heat the tile floor.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A flooring system consisting of:
A) a plurality of sheets, each sheet including a first surface that is a top surface when the sheet is in use, a first edge, and a second edge, and an electrical resistance heating wire embedded therein1 the plurality of sheets including
(1) a starting sheet,
(2) an ending sheet,
(3) a middle sheet, and
(4) a earner sheet;
B) a first connector on the first edge of each sheet;
C) a second connector on the second edge of each sheet;
D) the first and second connectors being electrically connected to the heating wire embedded in each sheet and being adapted so that a first connector on one sheet can be electrically connected to a second connector on an adjacent sheet whereby a single electrical circuit is defined through a floor formed of the plurality of sheets;
E) sheet connectors on each sheet, the sheet connectors being adapted to physically connect each sheet to at least one adjacent sheet;
F) a power source;
G) a thermostat connected to the starting end and ending sheets and to the power source;
H) a thermometer connected to one of the sheets and to the thermostat; and
(I) a marking indicia on the first surface of each sheet, with to marking indicia being congruent with the heating wire embedded in the sheet.

2. The flooring system defined in claim 1 wherein the electrical resistance heating wire is in a sinuous form in each sheet.

3. (canceled)

4. A flooring system consisting of:
A) a plurality of sheets, each sheet including a first surface that is a top surface when the sheet is in use, a first edge, and a second edge, and an electrical resistance heating wire embedded therein;
B) a first connector on the first edge of each sheet,
C) a second connector on the second edge of each sheet;
D) the first and second connectors being electrically connected to the heating wire embedded in each sheet and being adapted so that a first connector on one sheet can be electrically connected to a second connector on an adjacent sheet whereby a single electrical circuit is defined through a floor formed of the plurality of sheets;
E) sheet connectors on each sheet, the sheet connectors being adapted to physically connect each sheet to at least one adjacent sheet;
F) a power source;
G) a thermostat connected to one connector of one of the sheets and to the power source; and
H) a thermometer connected to one of the sheets and to the thermostat.
